(19) United States
(12) Patent Application Publication
(10) Pub. No.: US 2026/0153076 A1
(43) Pub. Date: Jun. 4, 2026

(54) PITCH CONTROL METHOD AND SYSTEM BASED ON COOPERATIVE OPTIMIZATION FOR OFFSHORE WIND FARM

(71) Applicant: SHANDONG UNIVERSITY, Jinan (CN)

(72) Inventors: Guangchen WANG, Jinan (CN); Haiyang WANG, Jinan (CN); Mengxue GAO, Jinan (CN); Mi ZONG, Jinan (CN); Jing CHEN, Jinan (CN); Xinyu LIU, Jinan (CN); Yunze CHEN, Jinan (CN)

(21) Appl. No.: 19/401,594

(22) Filed: Nov. 26, 2025

(30) Foreign Application Priority Data
Nov. 29, 2024 (CN) 2024117297875

(51) Int. Cl. F03D 7/04; F03D 7/02

(52) U.S. Cl. CPC F03D 7/049; F03D 7/0224; F05B 2270/32; F05B 2270/328; F05B 2270/335; F05B 2270/404

(57) ABSTRACT

A pitch control method based on cooperative optimization for an offshore wind farm, may include: acquiring a power control signal and a load reduction control signal of each wind turbine cluster; and generating, according to the power control signal and the load reduction control signal, a pitch control command based on a preset optimal control objective, and transmitting the pitch control command to a corresponding pitch control action execution mechanism for pitch control; wherein the power control signal is determined by an arithmetic processing unit through processing wind turbine parameters and wind speed data of the offshore wind farm, with a control objective of maximizing output power of the offshore wind farm; and the load reduction control signal is generated by a single-turbine controller for the wind turbine cluster utilizing key features affecting power outputs of wind turbines in combination with a linear time-invariant dynamic model for the wind turbines.

### CROSS-REFERENCE TO RELATED APPLICATIONS

The present invention claims priority to Chinese Patent Application No. 202411729787.5, filed with the China National Intellectual Property Administration on Nov. 29, 2024, entitled “PITCH CONTROL METHOD AND SYSTEM BASED ON COOPERATIVE OPTIMIZATION FOR OFFSHORE WIND FARM”, the entire content of which is incorporated herein by reference and constitutes a part of the present invention for all purposes.

### TECHNICAL FIELD

The present invention relates to the technical field of wind power generation, and particularly, to a pitch control method and system based on cooperative optimization for an offshore wind farm.

### BACKGROUND

The statements in this section merely refer to the background art related to the present invention and do not necessarily constitute the prior art.

The trend toward larger and more efficient offshore wind farms is one of the key directions for the high-quality development of the offshore wind powers in the future. Due to the highly similar installation heights of wind turbines in the offshore wind farms, the wake effect of upstream wind turbines and the strong turbulence in the wake zone will reduce the power outputs of downstream wind turbines and further increase the fatigue load on the blades. Meanwhile, as the unit capacity increases, the size and weight of wind turbine components also increase. The trend toward larger unit equipment further exacerbates the wake effect between units, intensifies the impact of unbalanced load distribution on the operating conditions of the wind turbines, and causes fatigue to components such as pitch control mechanisms, bearings, and towers. The wind turbines in the entire wind farm are mutually coupled and influence each other, which severely restricts the output power and affects the operating conditions of the wind turbines.

A conventional pitch control strategy for wind turbines only focuses on the power generation performance and quality of a single turbine. This makes it difficult to balance fatigue management and power optimization, and fails to simultaneously achieve control objectives of cooperative optimization and load reduction of the wind farm. In addition, due to the relatively long distances between wind turbines in offshore wind farms, some wind turbines may be located far from the shore, making it difficult to maintain real-time communication with an onshore centralized control center, which further affects the response speed and stability of a system.

### SUMMARY

To overcome the deficiencies in the prior art, the present invention provides a pitch control method and system based on cooperative optimization for an offshore wind farm, an electronic device, a computer-readable storage medium, and a computer program product. The cooperative optimization and load reduction of the wind farm are achieved with low communication dependency, and the power generation efficiency of the wind farm and the operational safety of wind turbines are effectively improved.

In a first aspect, the present invention provides a pitch control method based on cooperative optimization for an offshore wind farm.

The pitch control method based on cooperative optimization for the offshore wind farm, including:
acquiring a power control signal and a load reduction control signal of each wind turbine cluster; and
generating, according to the power control signal and the load reduction control signal, a pitch control command based on a preset optimal control objective, and transmitting the pitch control command to a corresponding pitch control action execution mechanism for pitch control;
wherein, the power control signal is determined by an arithmetic processing unit through processing wind turbine parameters and wind speed data of the offshore wind farm, with a control objective of maximizing output power of the offshore wind farm; and the load reduction control signal is generated by a single-turbine controller for the wind turbine cluster utilizing key features affecting power outputs of wind turbines in combination with a linear time-invariant dynamic model for the wind turbines.

In some implementation modes, the wind turbine cluster is divided and determined through a central processing unit by constructing a coupling relationship matrix between the wind turbines to establish a wind farm network.

In some implementation modes, dividing the wind turbine cluster by constructing the coupling relationship matrix between the wind turbines to establish the wind farm network specifically includes:
acquiring real-time operational data of the offshore wind farm, and processing the real-time operational data through a correlation analysis method to determine the key features;
constructing a directed graph of the wind farm network based on the key features; analyzing wake-effect-related coupling by using historical operational data of the offshore wind farm, assigning a weight to each edge in the directed graph of the wind farm network, and determining an adjacency matrix of the wind farm network; and
clustering the directed graph of the wind farm network through a K-means clustering algorithm to determine the wind turbine cluster and a corresponding control center.

In some implementation modes, the generating, according to the power control signal and the load reduction control signal, the pitch control command based on the preset optimal control objective specifically includes: performing iterative optimization with objectives of fatigue management and power optimization according to a unified component corresponding to the power control signal and a cosine component and a sine component corresponding to the load reduction control signal, to generate the pitch control command.

In some implementation modes, determining the power control signal by processing the wind turbine parameters and the wind speed data of the offshore wind farm, with the control objective of maximizing output power of the offshore wind farm specifically includes:
performing iterative optimization based on the wind turbine parameters of the wind turbine cluster, with a wind speed of the wind turbine cluster as an input, a shielding effect of the wind turbines on incoming wind as an optimization parameter, and a dispatching objective of maximizing output power of the entire wind farm to determine the power control signal of each wind turbine cluster;
wherein, wind speed data of a downstream wind turbine cluster is determined according to wind speed data of an upstream wind turbine cluster.

In some implementation modes, generating the load reduction control signal utilizing the key features affecting power outputs of wind turbines in combination with the linear time-invariant dynamic model for the wind turbines specifically includes:
acquiring a nonlinear aerodynamic motion equation of a wind generator set and performing linearization to establish a linearized dynamic equation model; and
transforming a linearized aerodynamic load model into a state-space model for wind turbine loads by using MBC coordinate transformation, and solving the state-space model for the wind turbine load through a control algorithm to generate the load reduction control signal.

In a second aspect, the present invention provides a pitch control system based on cooperative optimization for an offshore wind farm.

The pitch control system based on cooperative optimization for the offshore wind farm, including:
an arithmetic processing unit, configured to determine a power control signal by processing wind turbine parameters and wind speed data of the offshore wind farm, with a control objective of maximizing output power of the offshore wind farm;
a single-turbine controller, configured to generate a load reduction control signal utilizing key features affecting power outputs of wind turbines in combination with a linear time-invariant dynamic model for the wind turbines;
a control unit, configured to: acquire the power control signal and the load reduction control signal of each wind turbine cluster; and
generate, according to the power control signal and the load reduction control signal, a pitch control command based on a preset optimal control objective, and transmit the pitch control command to a corresponding pitch control action execution mechanism for pitch control; and
a pitch control action execution unit, configured to acquire the pitch control command and perform pitch control.

In a third aspect, the present invention provides an electronic device.

The electronic device includes a memory, a processor, and a computer program stored on the memory, wherein the processor executes the computer program to implement steps of the pitch control method based on cooperative optimization for the offshore wind farm described above.

In a fourth aspect, the present invention provides a computer-readable storage medium.

The computer-readable storage medium, having a computer program/instruction stored thereon, wherein when the computer program/instruction is executed by a processor, causing the processor to implement steps of the pitch control method based on cooperative optimization for the offshore wind farm described above.

In a fifth aspect, the present invention provides a computer program product.

The computer program product includes a computer program/instruction, wherein when the computer program/instruction is executed by a processor, causing the processor to implement steps of the pitch control method based on cooperative optimization for the offshore wind farm described above.

Compared with the prior art, the present invention has the following beneficial effects:

1. In the technical solution provided by the present invention, the large offshore wind farm is divided based on relative positions of the wind turbines and impact of wind turbine actions, a dynamic wake effect-based cooperative optimization model for the offshore wind farm is established based on wind turbine cluster division and a wake effect model for the wind farm, and output powers of different wind turbine clusters are rapidly calculated by the arithmetic processing unit.

According to an operating state of a single wind turbine and environmental factors, the key features are extracted to establish a simplified load model for describing aerodynamic loads of the wind turbines. Three pitch angles are converted into three mutually decoupled components for power control and load control using the MBC coordinate transformation. The single-turbine controller generates the load reduction control signal. In combination with a power tracking control signal and the load reduction control signal, the control command is generated based on the optimal control objective. The communication dependency of different wind turbine clusters on a central control node is minimized. Compared with a conventional multi-wind-turbine wake effect model, the model complexity is lowered, the computational load is reduced, and the stability and adaptability of the control system are improved.

The use of this method achieves cooperative control of the offshore wind farm, balances fatigue management and power optimization, and overcomes the shortcomings of a conventional pitch control strategy for wind turbines, which only focuses on the power generation performance and quality of a single turbine, cannot execute cooperative control commands, and has high communication demands and poor stability.

2. In the technical solution provided by the present invention, the central processing unit divides the large offshore wind farm by dividing the wind turbines with high coupling degrees into a plurality of small clusters according to network weight values based on the collected environmental data of the wind farm and operational data of the single turbine, which greatly reduces the communication dependency. The units such as the arithmetic processing unit are used to achieve cooperative control of the offshore wind farm. Fatigue management and power optimization are balanced. The use of this system can effectively reduce the communication dependency, achieve control objectives of cooperative optimization and load reduction of the wind farm with low communication dependency, and effectively improve the power generation efficiency of the wind farm and the operational safety of the wind turbines.

### BRIEF DESCRIPTION OF THE DRAWINGS

The accompanying drawings constituting a part of the present invention are used to provide further understanding of the present invention. The schematic embodiments of the present invention and their descriptions are used to explain the present invention and do not constitute an improper limitation to the present invention.

FIG. 1 is a schematic flowchart of a pitch control method based on cooperative optimization for an offshore wind farm according to an example of the present invention;

FIG. 2 is a schematic flowchart of wind turbine cluster division in an offshore wind farm according to an example of the present invention;

FIG. 3 is a schematic flowchart of generating a pitch control command according to an example of the present invention; and

FIG. 4 is a schematic diagram of a system architecture for a pitch control method based on cooperative optimization for an offshore wind farm according to an example of the present invention.

### DETAILED DESCRIPTION

It should be pointed out that the following detailed descriptions are all exemplary and are intended to provide further illustration of the present invention. Unless otherwise specified, all the technical and scientific terms used in the present invention have the same meanings as those commonly understood by those of ordinary skill in the art to which the present invention belongs.

It is to be noted that the terms used herein are only for describing specific embodiments, and are not intended to limit exemplary embodiments according to the present invention. As used herein, unless otherwise explicitly indicated in the context, the singular form is also intended to include the plural form. In addition, it should also be understood that the terms “include/including”, “comprise/comprising”, and any variation thereof are intended to cover non-exclusive inclusion. For example, processes, methods, systems, products or devices including a series of steps or units are not necessarily limited to clearly listed steps or units, but may include steps or units not clearly listed, or other steps or units inherent to these processes, methods, products or devices.

In the absence of a conflict, the embodiments in the present invention can be combined with the features in the embodiments.

### Example 1

A conventional pitch control strategy for wind turbines only focuses on the power generation performance and quality of a single turbine. This makes it difficult to achieve cooperative control of a wind farm, fails to balance fatigue management and power optimization, and imposes high communication demands, ultimately affecting the response speed and stability of a system. Therefore, the present invention provides a pitch control method based on cooperative optimization for an offshore wind farm.

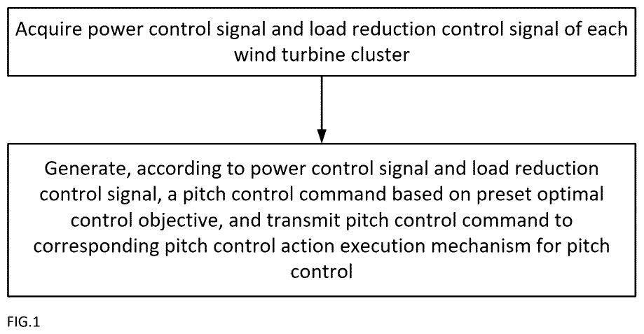

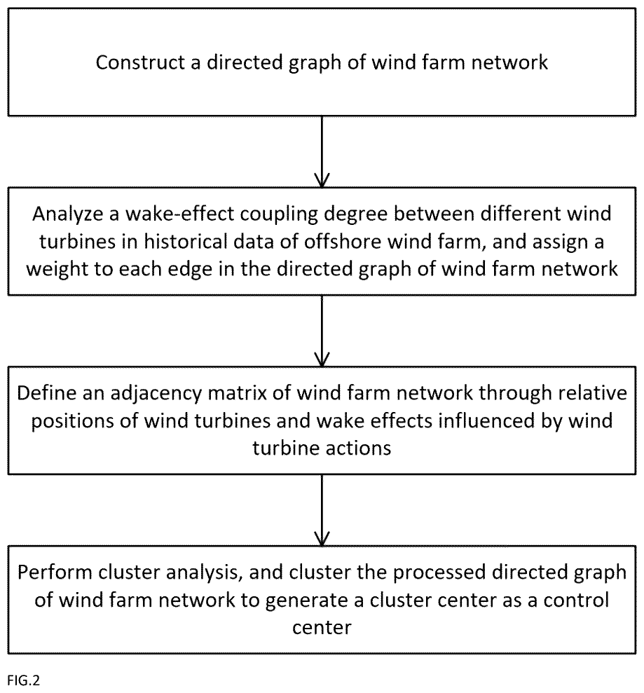

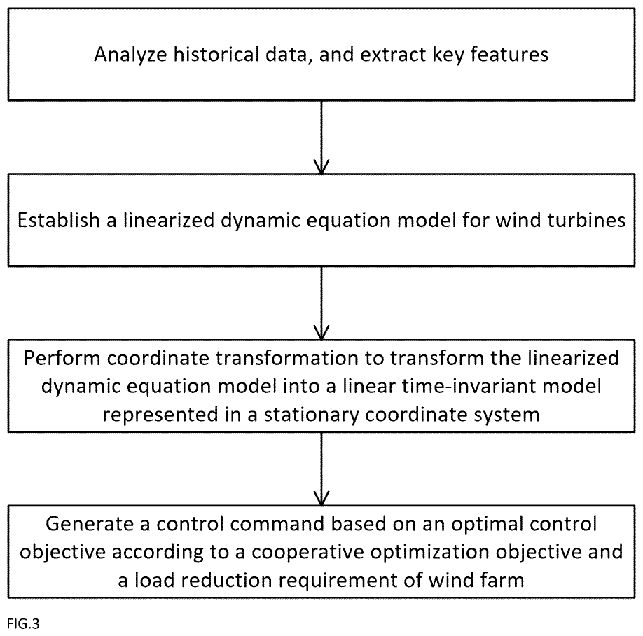

Next, the pitch control method based on cooperative optimization for the offshore wind farm disclosed in the present example is descried in detail with reference to FIG. 1 to FIG. 3. And, the pitch control method based on cooperative optimization for the offshore wind farm is applied to a control unit and includes the following steps.

S1: acquiring a power control signal and a load reduction control signal of each wind turbine cluster.

To reduce the communication dependency of the pitch control based on cooperative optimization for the offshore wind farm, prior to performing S1, a central processing unit divides the offshore wind farm into a plurality of wind turbine clusters. As an implementation mode, this process specifically includes the following steps.

(1) Real-time operational data of offshore wind turbines is acquired, a real-time wind speed, a wind direction, a power output, a system load, and environmental status data are extracted from the real-time operational data, and data cleaning, anomaly detection, and normalization processing are performed.

In the present example, the real-time operational data is collected via a supervisory control and data acquisition (SCADA) system.

(2) The processed data is analyzed through a correlation analysis method to determine key features affecting power outputs and load demands of wind turbines.

Specifically, the correlation analysis method may be a Pearson correlation coefficient, a Spearman rank correlation coefficient, etc.

In the present example, the Pearson correlation coefficient between the processed data and the power and load demands of the wind turbines is calculated, and the key features are filtered based on a magnitude of the Pearson correlation coefficient to determine final key features, where the final key features include an effective wind speed at a blade.

(3) Based on the key features, a directed graph G=(V, A, W) of the wind farm network is constructed, wherein a node set V represents each wind turbine, an edge set A represents an association relationship among the wind turbines, and W represents an adjacency matrix.

(4) Historical operational data of the offshore wind farm is acquired; based on actually measured data of a wake effect degree of each wind turbine in the wind farm over a period of time from the historical operational data, the wake impact degree of each wind turbine, a wake overlap area, a wind turbine rotor diameter, and a relative distance between adjacent wind turbine arrays are analyzed; and a weight is assigned to each edge in the directed graph of the wind farm network, which represents the strength of coupling between the wind turbines. Then, the adjacency matrix of the wind farm network can thus be defined as W=(ωᵢⱼ), ωᵢⱼ=f(S, D, R), wherein S represents the wake overlap area, D represents the wind turbine rotor diameter, and R represents the relative distance between the adjacent turbine arrays.

By way of example, the historical operational data includes wind speed, air pressure, and turbulence intensity upstream and downstream of each wind turbine in the wind farm over a period of time. Computational fluid dynamics (CFD) simulation software is used to perform simulation to acquire the wake effect intensity of each wind turbine.

The CFD simulation software is existing software. When in use, the wind speed, the air pressure, and the turbulence intensity upstream and downstream of each wind turbine in the wind farm over a period of time are input to the CFD simulation software, and the CFD simulation software processes the data and directly outputs the corresponding wake effect intensity of each wind turbine.

A wake overlap area, a wind turbine rotor diameter, and a relative distance between adjacent wind turbine arrays for an upstream wind turbine corresponding to each wind turbine are collected, and regression analysis is performed on the wake overlap area, the wind turbine rotor diameter, and the relative distance between the adjacent wind turbine arrays for the upstream wind turbine corresponding to each wind turbine to obtain a relationship with the wake effect intensity, which is expressed as:

$$f ( S , D , R ) = aS + bD + cR ;$$

wherein, a, b, and c are regression coefficients obtained through the aforementioned regression analysis.

Finally, according to f(S, D, R), a weight is assigned to each edge in the directed graph of the wind farm network.

(5) All mutually directed nodes on the directed graph of the wind farm network are processed according to a preset determination threshold.

Specifically, a weight value of an edge with a weight less than the determination threshold is subtracted from a weight value of an edge with a weight greater than the determination threshold, and an obtained weight difference is used as a weight difference for retaining the edge with the weight greater than the determination threshold, while the edge with the weight less than the determination threshold is deleted.

The determination threshold is expressed as:

$$ε = k ( {ω}_{ij} ) \overline{ε} ;$$

wherein, k represents a deletion determination parameter, and ¿ represents an average value of the wake intensity.

(6) The processed directed graph of the wind farm network is clustered using a K-means clustering algorithm.

Specifically, a similarity matrix and a standard Laplacian matrix are constructed for the processed directed graph of the wind farm network, the constructed similarity matrix and standard Laplacian matrix are input as a clustering sample set, the number of clusters K and the number of iterations n are set, and the K-means clustering algorithm is run for clustering.

The K-means algorithm is a type of dynamic clustering algorithm, which first performs rough pre-classification, then conducts gradual iterative adjustments, and updates after a set cycle to achieve dynamic division of wind turbine clusters.

To achieve cooperative optimization control of the offshore wind farm and balance fatigue management and power optimization, the power control signal and the load reduction control signal need to be determined. In the present example, the power control signal is determined by an arithmetic processing unit through processing the real-time operational data and environmental data of the offshore wind farm, with a control objective of maximizing output power of the offshore wind farm, and is output to a control unit; and the load reduction control signal is generated by a single-turbine controller for the wind turbine cluster utilizing the key features affecting the power outputs of the wind turbines in combination with a linear time-invariant dynamic model for the wind turbines, and is output to the control unit.

As an implementation mode, the specific process of determining a power control signal by processing real-time operational data and environmental data of the offshore wind farm, with a control objective of maximizing output power of the offshore wind farm is as follows.

In step 1, a real-time wind speed, a wind direction, and wind turbine parameters of the wind farm are acquired, and output power of an upstream wind turbine cluster is calculated.

By way of example, the output power of the upstream wind turbine cluster is expressed as:

$$P = {\sum }_{k = 1}^{n} \frac{1}{2} ρ π {r}^{2} {v}^{3} {c}_{p} ( {a}_{i} ) ;$$

wherein, n represents the number of wind turbines in the upstream wind turbine cluster, ρ represents an air density, r represents a wind turbine rotor radius, v represents the real-time wind speed, cₚ represents a rotor power coefficient, and aᵢ represents a shielding effect of the wind turbines on incoming wind.

In step 2, an environmental wind speed of a downstream wind turbine cluster is determined based on the wind speed and the wind direction of the upstream wind turbine cluster, and then output power of the downstream wind turbine cluster is calculated; and with a dispatching objective of maximizing output power of the entire wind farm, the central processing unit calculates and allocates the power control signal of each wind turbine cluster.

The environmental wind speed of the downstream wind turbine cluster is determined based on the wind speed and the wind direction of the upstream wind turbine cluster, and the environmental wind speed of the downstream wind turbine cluster is substituted into the aforementioned output power calculation formula to obtain the output power of the downstream wind turbine cluster.

With the dispatching objective of maximizing the output power of the entire wind farm, the power of each wind turbine cluster is iteratively calculated within the entire wind farm, which is expressed as:

$$\{ \begin{matrix}\begin{matrix}{P}_{i} = {\sum }_{k = 1}^{n} \frac{1}{2} ρ π {r}^{2} {v}^{3} {c}_{p} ( {a}_{i} ) \\ P = max {\sum }_{i = 1}^{n} {P}_{i}\end{matrix} \\ 0 \leq {P}_{i} \leq {P}_{R P}\end{matrix} ;$$

wherein, P represents the output power of the entire wind farm, Pᵢ represents output power of an i^{th} wind turbine cluster, ρ represents the air density, r represents the wind turbine rotor radius, v represents the wind speed at the wind turbines, aᵢ represents the shielding effect of the wind turbines on the incoming wind,

$${a}_{i} = \frac{{v}_{0} - v}{{v}_{0}} ,$$

and P_{RP} represents rated power of the wind turbines.

In the present example, the power is described as a function of the shielding effect of the wind turbines on the incoming wind to obtain a power control command, and in combination with a motion equation of a rotor, power control of the wind turbines is implemented by controlling a pitch angle of the wind turbines to achieve the corresponding shielding effect. The motion equation of the rotor is expressed as:

$$J \dot{ω} = 3 ( - {h}_{1} \dot{x} + {h}_{2} {β}_{1} + {h}_{1} v - {T}_{g} ) ;$$

wherein, \dot{x} is a movement speed of a tower, J is rotational inertia of the rotor, v is the wind speed at the wind turbines, \dot{ω} is an angular velocity of the rotor, T_{g} is a generator torque, β₁ is a unified component of a blade pitch after coordinate transformation, i.e., a first component in u=[β₁ β₂ β₃]^{T} below, h₁ is a partial derivative of a blade torque with respect to the effective wind speed, and h₂ is a partial derivative of the blade torque with respect to the pitch angle.

Specifically, the iterative optimization is performed through an intelligent optimization algorithm with the real-time wind speed of the wind turbine cluster as an input and aᵢ as an optimization parameter of the intelligent optimization algorithm to solve for a set of optimal or near-optimal control variables. The intelligent optimization algorithm herein may be an ant colony algorithm, a grey wolf algorithm, or a particle swarm algorithm. The present example does not improve the intelligent optimization algorithm, which will not be repeated herein.

In this step, considering that the wind speed and the wind direction of downstream wind turbines differ due to the shielding effect from upstream wind turbines, the downstream wind speed is calculated using a numerical simulation method based on the wind speed and the wind direction of the upstream wind turbine cluster, and the calculated downstream wind speed is then substituted into the output power calculation formula for calculating the power of the downstream wind turbines. The numerical simulation method may utilize an existing engineering wake model such as a Jensen model, a Frandsen model, or a Gaussian model to calculate the downstream wind speed.

Next, taking the Jensen model as an example, the process of determining the environmental wind speed of the downstream wind turbine cluster based on the wind speed and the wind direction of the upstream wind turbine cluster is specifically described as follows:

Assuming a wake profile is flat-topped, a velocity decay coefficient derived from the law of mass conservation can be expressed as:

$$δ ( x ) = {( \frac{D}{D + 2 K l} )}^{2} ( 1 - \sqrt{1 - {C}_{t}} ) ;$$

wherein, δ is the velocity decay coefficient, l is an axial distance downstream of the wind turbine, which can reflect the wind direction, Cₜ is a thrust coefficient of the wind turbine, D is a blade diameter of the upstream wind turbine, and k is a wake decay constant. Then, the wind speed at the downstream wind turbine is expressed as:

$$V = {v}_{0} δ ( x ) ;$$

wherein, v₀ represents a natural wind speed, i.e., a real-time wind speed at the upstream wind turbine cluster.

In some implementation modes, the wind speed downstream may also be determined using a fluid dynamics model.

Specifically, a Navier-Stokes equation controlling an entire flow field in the wind farm is established for numerical solving. If the fluid dynamics model is an eddy viscosity model (EVM) of wake, it is assumed that a wake zone is axisymmetric, and the wind turbine wake with an axisymmetric structure is calculated using eddy viscosity constraints and a Reynolds-averaged N-S equation, which can be expressed as:

$$1 - \frac{V}{{v}_{0}} = K exp \{ - 3.56 {( \frac{l}{b} )}^{2} \} ;$$

wherein, v₀ represents the natural wind speed, V represents a wind speed at the downstream wind turbine, i.e., a wind speed at the axial distance/downstream of the wind turbine, K represents an initial wind speed decay at a centerline of the wake, and b represents a wake width.

As an implementation mode, the specific process of generating a load reduction control signal utilizing key features affecting power outputs of wind turbines in combination with a linear time-invariant dynamic model for the wind turbines is as follows.

In (a), based on a nonlinear aerodynamic motion equation of a wind generator set, blades are regarded as rigid blades; the nonlinear aerodynamic motion equation is linearized near a steady-state operating point; key features are extracted to establish a linearized dynamic equation model; and wind turbine loads are described.

The nonlinear aerodynamic motion equation is expressed as:

$$M \ddot{x} + C \dot{x} + B x = {F}_{t} ;$$

wherein, M is a mass matrix of the system, C is a damping matrix of the system, B is a stiffness matrix of the system, Fₜ represents a thrust of the natural wind on the wind turbine rotor at time t, and x represents a displacement at the top of the tower.

Specifically, the aforementioned nonlinear aerodynamic motion equation describes tower movement caused by the thrust. By introducing small perturbations to variables in the nonlinear aerodynamic motion equation near the steady-state operating point and using Taylor expansion, a linearized equation is obtained, and then a linearized aerodynamic load model is obtained.

The linearized aerodynamic load model is expressed as:

$$δ {M}_{i} = K {β}_{i} + h {v}_{i} ;$$

wherein, δMᵢ is a variation of a bending moment in a flapwise direction at the root of an i^{th} blade; βᵢ represents a pitch angle of the i^{th} blade; vᵢ represents an effective wind speed in the flapwise direction at the i^{th} blade; K is a partial derivative of the bending moment with respect to the pitch angle at the operating point, and h is a partial derivative of the bending moment with respect to the relative wind speed at the operating point.

The representation of the effective wind speed is related to the change in a blade azimuth angle, and the effective wind speed is expressed as:

$${v}_{i} = {u}_{i} - {v}_{f} - cos {ψ}_{i} \frac{9 R}{8 H} {v}_{f} ;$$

wherein, v_{f} is an axial velocity at the top of the tower; uᵢ is an absolute wind speed of the i^{th} blade; ψᵢ is a spatial position angle of the i^{th} blade, which is 0° when the blade is vertically upward; R is a blade radius; and H is a tower height.

The linearized aerodynamic load model is a periodic time-varying model. The periodic time-varying model refers to a load model established directly from a physical model. An expression for the bending moment includes a rotor azimuth angle. The azimuth angle changes continuously during one rotation of the blade, which is unfavorable for control. Therefore, the time-varying model needs to be transformed into a time-invariant model through coordinate transformation.

In (b), the linearized aerodynamic load model is transformed into a linear time-invariant model represented in a stationary coordinate system by using a Multivariable control (MBC) coordinate transformation.

Since the periodic time-varying model includes a periodic coefficient related to the rotor azimuth angle, and the pitch angles of the three blades are interrelated and jointly affect the output powers and aerodynamic loads of the wind turbines, it is difficult to design a controller using a conventional control strategy. To apply the linear time-invariant model, in the present example, an MBC coordinate transformation matrix is multiplied by the pitch angles of the three blades in the three-bladed wind turbine, thereby transforming the pitch angles of the three blades in the three-bladed wind turbine into a unified component related to generating power, and a cosine component and a sine component related to a blade root load.

Here, the MBC coordinate transformation matrix is expressed as:

$$T = \frac{1}{3} [ \begin{matrix}1 & 1 & 1 \\ 2 cos {ψ}_{1} & 2 cos {ψ}_{2} & 2 cos {ψ}_{3} \\ 2 sin {ψ}_{1} & 2 sin {ψ}_{2} & 2 sin {ψ}_{3}\end{matrix} ] .$$

After MBC coordinate transformation, a load calculation expression is transformed into a linear time-invariant form. Unbalanced loads borne by the rotor mainly include a pitching bending moment and a yawing bending moment. A state-space model for wind turbine loads is established by selecting a fore-aft displacement and a velocity at the top of the tower as state variables, a pitch angle as a control input, and a pitching bending moment and a yawing bending moment as output variables.

The state-space model for wind turbine loads is expressed as:

$$\{ \begin{matrix}\dot{x} = Ax ( t ) + Bu ( t ) + {B}_{d} d ( t ) \\ y = Cx ( t )\end{matrix} ;$$

wherein, A represents a system matrix, B represents an input matrix, B_{d} represents a wind speed input matrix, C represents an output matrix, x(t) represents the displacement and velocity at the top of the tower, i.e., x(t)=[x, \dot{x}]^{T}, the control input is a pitch angle, represented by a cosine component and a sine component u=[β₂ β₃]^{T}, β₂ and β₃ are respectively the cosine component and the sine component, and d (t) represents a wind speed input.

Wherein, A, B, and C are coefficient matrices, and the selection of the specific coefficient matrices is determined by those skilled in the art according to actual situations.

In (c), after being obtained, the state-space model for wind turbine loads is solved using a PID control algorithm to obtain the value of u=[β₂ β₃]^{T}.

In S2, a pitch control command is generated according to the power control signal and the load reduction control signal based on a preset optimal control objective, and the pitch control command is transmitted to a corresponding pitch control action execution mechanism for pitch control.

Specifically, in the above step, the unified component is obtained from the power control signal, and the cosine component and the sine component are obtained from the load reduction control signal. For the requirements of cooperative optimization and load reduction of the wind farm, control commands are generated based on the optimal control objective, and pitch angles are adjusted such that J(U) reaches its minimum value, thereby obtaining optimal component control commands. J(U) is expressed as:

$$J ( U ) = \frac{1}{2} {\int }_{0}^{T} [ {{Q}_{t} ( {u}_{t} - {U}^{*} )}^{2} + {R}_{t} f ( {x}_{t} ) ] d t ;$$

wherein, uₜ represents a blade pitch angle of the wind turbine; U* represents a set pitch angle, and it should be noted that the pitch angle at this time is a component after coordinate transformation and a set value calculated by the arithmetic processing unit and the single-turbine controller; Qₜ and Rₜ are weight matrices; and f(xₜ) represents a fatigue model for a wind turbine system, which is a model for reflecting fatigue conditions of other components of the wind turbine.

Here, the preceding term of J(U) represents a tracking status of the command, while the succeeding term represents an operating condition of the wind turbine. The practical significance lies in balancing fatigue management and power optimization, and allowing each wind turbine to make minor adjustments based on the given command to better achieve the dual objectives of fatigue management and power optimization.

In the present example, the fatigue model for the wind turbine system is established through the key physical features extracted in the above step.

Specifically, state variables such as a tower fore-aft vibration mode and an average blade flapwise mode are selected to describe fatigue caused by oscillations resulting from random wind disturbances and wind turbine operation. For example, tower vibration, blade vibration, and shafting vibration caused by frequent torque changes are described. The vibrations are related to the changes in the pitch angle of the wind turbine. The operating condition of a single turbine can be described, but modeling is complex and explicit expression is lacking.

In the present example, the fatigue caused by oscillations and frequent changes in mechanisms is reduced by limiting the displacement and velocity of relevant physical quantities. The fatigue model is expressed as:

$$f ( {x}_{t} ) = {a}_{0} {x}^{2} + {a}_{1} {\dot{x}}^{2} + {a}_{2} {\dot{u}}_{t}^{2} ;$$

wherein, x may be selected as a fore-aft displacement of the tower, with the first derivative thereof representing a movement speed of the tower; uₜ represents a blade pitch angle of the wind turbine; and a₀, a₁, and a₂ are coefficients set by technical personnel according to different requirements. Thus, during control, the fatigue caused by wind turbine vibration and frequent changes in a pitch control bearing is reduced by limiting tower vibration and the rate of change of the pitch angle.

Then, the three component control commands undergo MBC inverse transformation to obtain independent pitch control angle commands in a rotating coordinate system, and these commands are sent to the pitch control action execution mechanism to execute a pitch control action, thereby completing independent pitch control.

### Example 2

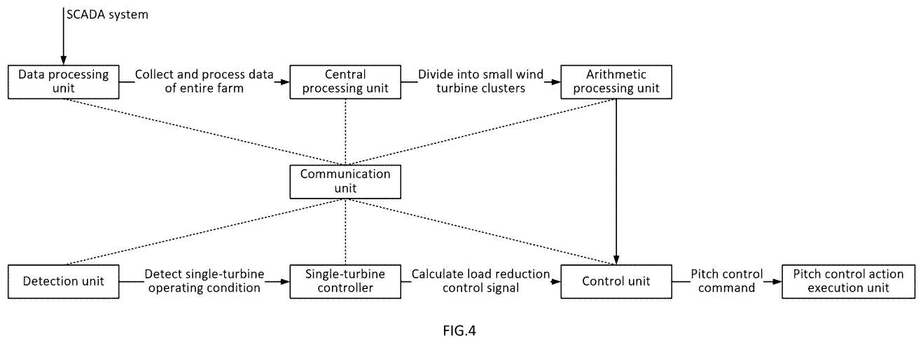

Referring to FIG. 4, based on the Example 1, the present example discloses a pitch control system based on cooperative optimization for an offshore wind farm, including a data processing unit, a central processing unit, an arithmetic processing unit, a single-turbine controller, a communication unit, a control unit, a detection unit, and a pitch control action execution unit.

The data processing unit is configured to connect to a SCADA system to collect and acquire real-time operational data, including a real-time wind speed, a wind direction, a power output, a system load, and environmental status data of the wind farm, and to perform data cleaning and anomaly detection on the collected data.

The central processing unit is configured to define a wind farm network based on a wake effect of the offshore wind farm and an impact of wind turbine actions, divide wind turbines with high coupling degrees into a plurality of small clusters according to network weight values, analyze a change in a wind farm network degree based on control variables provided by distributed cluster optimization and a dynamic wind turbine model, determine whether to update a cluster division result, and update the wind farm network and the cluster division result within a certain period.

The arithmetic processing unit is configured to determine a power control signal by processing wind turbine parameters and wind speed data of the offshore wind farm, with a control objective of maximizing output power of the offshore wind farm.

The detection unit is configured to detect physical quantities such as a rotational speed of the wind turbine, a bending moment at the root of the blade, and an environmental wind speed.

The single-turbine controller is configured to generate a load reduction control signal of the wind turbine according to single-turbine operational information collected by the detection unit and a wind turbine load model based on optimal control index calculation. The control unit is configured to receive the power control signal output by the arithmetic processing unit and the load reduction control signal output by the single-turbine controller, calculate control commands for three blade components, perform MBC inverse transformation to further obtain actual pitch control angles of three blades, and send them to the pitch control action execution unit.

The pitch control action execution unit is configured to receive the control signals from the control unit and implement a pitch control action through an electrical actuation mechanism.

### Example 3

The present example of the present invention provides an electronic device, including a memory, a processor, and a computer instruction stored on the memory and executed on the processor. When the computer instruction is executed by the processor, steps of the pitch control method based on cooperative optimization for the offshore wind farm described above are implemented.

### Example 4

The present example of the present invention provides a computer-readable storage medium for storing a computer instruction. When the computer program is executed by a processor, steps of the pitch control method based on cooperative optimization for the offshore wind farm described above are implemented.

### Example 5

The present example of the present invention provides a computer program product, including a computer program/instruction. When the computer program/instruction is executed by a processor, steps of the pitch control method based on cooperative optimization for the offshore wind farm described above are implemented.

The present invention is described with reference to the flowcharts and/or the block diagrams of the method, the device (system), and the computer program product according to the embodiments of the present invention. It should be understood that each process and/or block in the flowchart and/or the block diagram and combination of processes and/or blocks in the flowchart and/or the block diagram may be implemented by computer program instructions. These computer program instructions may be provided to a general-purpose computer, a special-purpose computer, an embedded processor, or a processor of other programmable data processing equipment so as to give rise to a machine with the result that the instructions executed by the computer or the processor of other programmable data processing equipment give rise to a device that is configured to implement the functions designated by one or more processes in the flowchart and/or one or more blocks in the block diagram.

These computer program instructions may also be stored in a computer-readable memory that can direct the computer or another programmable data processing device to function in a particular manner, such that the instructions stored in the computer-readable memory produce a manufactured article including an instruction apparatus that implements the functions designated by one or more processes in the flowchart and/or one or more blocks in the block diagram.

These computer program instructions may also be loaded on the computer or another programmable data processing device to perform a series of operation steps on the computer or another programmable device to generate the process implemented by the computer, such that the instructions executed by the computer or another programmable device provide steps used to implement the functions designated by one or more processes in the flowchart and/or one or more blocks in the block diagram.

In the above embodiments, the description of each embodiment has its own emphasis. For parts that are not detailed in a certain embodiment, reference can be made to the relevant descriptions of other embodiments.

The above descriptions are only preferred embodiments of the present invention and are not used to limit the present invention. For those skilled in the art, the present invention may have various modifications and variations. Any modifications, equivalent substitutions, improvements, etc. made within the spirit and principle of the present invention shall all be included within the scope of protection of the present invention.

1. A pitch control method based on cooperative optimization for an offshore wind farm, comprising:
acquiring a power control signal and a load reduction control signal of each wind turbine cluster; and
generating, according to the power control signal and the load reduction control signal, a pitch control command based on a preset optimal control objective, and transmitting the pitch control command to a corresponding pitch control action execution mechanism for pitch control;
wherein, the power control signal is determined by an arithmetic processing unit through processing wind turbine parameters and wind speed data of the offshore wind farm, with a control objective of maximizing output power of the offshore wind farm; the load reduction control signal is generated by a single-turbine controller for the wind turbine cluster utilizing key features affecting power outputs of wind turbines in combination with a linear time-invariant dynamic model for the wind turbines;
the generating, according to the power control signal and the load reduction control signal, a pitch control command based on a preset optimal control objective specifically comprises:
performing iterative optimization with objectives of fatigue management and power optimization according to a unified component corresponding to the power control signal and a cosine component and a sine component corresponding to the load reduction control signal, to generate the pitch control command;
determining the power control signal by processing wind turbine parameters and wind speed data of the offshore wind farm, with a control objective of maximizing output power of the offshore wind farm specifically comprises:
performing iterative optimization based on the wind turbine parameters of the wind turbine cluster, with a wind speed of the wind turbine cluster as an input, a shielding effect of the wind turbines on incoming wind as an optimization parameter, and a dispatching objective of maximizing output power of the entire wind farm to determine the power control signal of each wind turbine cluster,
wherein, wind speed data of a downstream wind turbine cluster is determined according to wind speed data of an upstream wind turbine cluster; and
generating the load reduction control signal utilizing key features affecting power outputs of wind turbines in combination with a linear time-invariant dynamic model for the wind turbines specifically comprises:
acquiring a nonlinear aerodynamic motion equation of a wind generator set and performing linearization to establish a linearized dynamic equation model; and
transforming a linearized aerodynamic load model into a state-space model for wind turbine loads by using a multivariable control (MBC) coordinate transformation, and solving the state-space model for the wind turbine load through a control algorithm to generate the load reduction control signal.

2. The pitch control method based on cooperative optimization for the offshore wind farm according to claim 1, wherein the wind turbine cluster is divided and determined through a central processing unit by constructing a coupling relationship matrix between the wind turbines to establish a wind farm network.

3. The pitch control method based on cooperative optimization for the offshore wind farm according to claim 2, wherein dividing the wind turbine cluster by constructing the coupling relationship matrix between the wind turbines to establish the wind farm network specifically comprises:
acquiring real-time operational data of the offshore wind farm, and processing the real-time operational data through a correlation analysis method to determine the key features;
constructing a directed graph of the wind farm network based on the key features; analyzing wake-effect-related coupling by using historical operational data of the offshore wind farm, assigning a weight to each edge in the directed graph of the wind farm network, and determining an adjacency matrix of the wind farm network; and
clustering the directed graph of the wind farm network through a K-means clustering algorithm to determine the wind turbine cluster and a corresponding control center.

4. A pitch control system based on cooperative optimization for an offshore wind farm, comprising:
an arithmetic processing unit, configured to determine a power control signal by processing wind turbine parameters and wind speed data of the offshore wind farm, with a control objective of maximizing output power of the offshore wind farm;
a single-turbine controller, configured to generate a load reduction control signal utilizing key features affecting power outputs of wind turbines in combination with a linear time-invariant dynamic model for the wind turbines;
a control unit, configured to: acquire the power control signal and the load reduction control signal of each wind turbine cluster; and
generate, according to the power control signal and the load reduction control signal, a pitch control command based on a preset optimal control objective, and transmit the pitch control command to a corresponding pitch control action execution mechanism for pitch control, a pitch control action execution unit, configured to acquire the pitch control command and perform pitch control,
wherein, the generating, according to the power control signal and the load reduction control signal, a pitch control command based on a preset optimal control objective specifically comprises: performing iterative optimization with objectives of fatigue management and power optimization according to a unified component corresponding to the power control signal and a cosine component and a sine component corresponding to the load reduction control signal, to generate the pitch control command;
determining the power control signal by processing wind turbine parameters and wind speed data of the offshore wind farm, with a control objective of maximizing output power of the offshore wind farm specifically comprises:
performing iterative optimization based on the wind turbine parameters of the wind turbine cluster, with a wind speed of the wind turbine cluster as an input, a shielding effect of the wind turbines on incoming wind as an optimization parameter, and a dispatching objective of maximizing output power of the entire wind farm to determine the power control signal of each wind turbine cluster,
wherein, wind speed data of a downstream wind turbine cluster is determined according to wind speed data of an upstream wind turbine cluster; and
generating the load reduction control signal utilizing key features affecting power outputs of wind turbines in combination with a linear time-invariant dynamic model for the wind turbines specifically comprises:
acquiring a nonlinear aerodynamic motion equation of a wind generator set and performing linearization to establish a linearized dynamic equation model; and
transforming a linearized aerodynamic load model into a state-space model for wind turbine loads by using MBC coordinate transformation, and solving the state-space model for the wind turbine load through a control algorithm to generate the load reduction control signal.

5. An electronic device, comprising a memory, a processor, and a computer program stored on the memory, wherein the processor executes the computer program to cause the processor to implement steps of the pitch control method based on cooperative optimization for the offshore wind farm according to claim 1.

6. A non-transitory computer-readable storage medium, having a computer program/instruction stored thereon, wherein when the computer program/instruction is executed by a processor, causing the processor to implement steps of the pitch control method based on cooperative optimization for the offshore wind farm according to claim 1.

7. A computer program product, comprising a computer program/instruction, wherein when the computer program/instruction is executed by a processor, causing the processor to implement steps of the pitch control method based on cooperative optimization for the offshore wind farm according to claim 1.
